(19) United States
(12) Patent Application Publication
(10) Pub. No.: US 2015/0102061 A1
(43) Pub. Date: Apr. 16, 2015

(54) MULTI-CHAMBER CONTAINER FOR STORING AND MIXING LIQUIDS

(71) Applicant: Solutions BioMed, LLC, Orem, UT (US)

(72) Inventors: Brian G. Larson, Alpine, UT (US); Jonathan George, Lehi, UT (US)

(21) Appl. No.: 14/052,623

(22) Filed: Oct. 11, 2013

(51) Int. Cl. B05B 11/00

(52) U.S. Cl. CPC B05B 11/0081; B05B 11/3043
USPC 222/129; 222/136

(57) ABSTRACT

The present disclosure is drawn to a multi-chamber container for storing and mixing fluids. The container can include a first chamber configured to contain a first liquid composition as well as a second chamber configured to contain a second liquid composition. A barrier can be operable to retain the first liquid composition within the first chamber. The multi-chamber container can further include a dispenser including a nozzle and an extraction tube for extracting fluid from the second chamber as well as a guide channel associated with the first chamber. The guide channel can be configured to guide the extraction tube into the second chamber such that the dispenser contacts the barrier in order to facilitate removal or reconfiguration of the barrier. Thus, the first liquid composition is allowed to contact the second liquid composition.

### BACKGROUND

Many compositions are prepared from two or more components which are not mixed together until shortly before use of the compositions. For example, some disinfectant or cleaning compositions include two or more components. In many such cases, at least one of the components can have a reduced chemical stability when diluted or some other reduced shelf-life once combined into the final compositions. Therefore, it can be beneficial to package some compositions as separate components in multi-component systems which can be combined shortly before use. Typically, individual components in a multi-component system are packaged at higher concentration, and then are manually combined in a final combined composition.

### BRIEF DESCRIPTION OF DRAWINGS

FIG. 1 is a cross-sectional schematic view of a multi-chamber container for storing and mixing fluids, including an insert module, in accordance with an embodiment of the present disclosure.

FIG. 2 is a perspective view of a first chamber and associated guide channel, collectively an insert or insert module, for storing and mixing liquids, in accordance with an embodiment of the present disclosure.

FIGS. 3A and 3B are cross-sectional schematic views of first chambers and associated guide channels for storing and mixing liquids, wherein FIG. 3A is similar to the embodiment shown in FIG. 2 (with an offset guide channel) while FIG. 3B shows a separate embodiment with the guide channel disposed centrally within a first chamber.

FIGS. 4A and 4B are top views of the first chamber and associated guide channel of the corresponding embodiments of FIGS. 3A and 3B, respectively, in accordance with embodiments of the present disclosure.

FIG. 5 is side view similar to the embodiments shown in FIGS. 2, 3A, and 4A, in accordance with another embodiment of the present disclosure.

FIGS. 6A-6C depict multiple sequential cross-sectional schematic views of a multi-chamber container for storing and mixing fluids for generating a foam in accordance with an embodiment of the present disclosure.

FIG. 7 is a lower perspective view of an insert module including a foaming dispenser, a second chamber, and a barrier in accordance with an embodiment of the present disclosure.

FIG. 8 is a side plan exploded view of an example foaming dispenser assembly usable with the two chamber systems of the present disclosure.

### DETAILED DESCRIPTION

Reference will now be made to the exemplary embodiments, and specific language will be used herein to describe the same. It will nevertheless be understood that no limitation of the scope of the disclosure is intended. Alterations and further modifications of the features illustrated herein, and additional applications of the principles of the disclosure as illustrated herein, which would occur to one skilled in the relevant art and having possession of this disclosure, are to be considered within the scope of the present technology. It is also to be understood that the terminology used herein is used for the purpose of describing particular embodiments only. The terms are not intended to be unduly limiting unless specified as such.

It is noted that, as used in this specification and the appended claims, the singular forms “a,” “an,” and “the” include plural referents unless the content clearly dictates otherwise.

The term “multi-part” when referring to a container or system of the present disclosure is not limited to containers or systems having only two or three parts. For example, a system can have any number of liquids (solutions, suspensions, or dispersions, for example) present in a single system.

The term “colloidal transition metals” refers to colloidal particles of elemental transitional metals or the alloys of such elemental transition metals. Colloidal transition metals are distinct from salts and oxides of transition metals. Accordingly, compounds such as silver oxide, silver nitrate, silver chloride, silver bromide, silver iodide, and the like are not colloidal transition metals.

In describing embodiments of the present disclosure, reference will be made to “first” or “second” as they relate to chambers, compartments, or liquid compositions, etc. It is noted that these are merely relative terms, and a chamber or composition described or shown as a “first” chamber or composition could just as easily be referred to a “second” chamber or composition, and such description is implicitly included herein.

Discussion of liquids or fluids herein does not require that each component be completely liquid. For example, a liquid or fluid can be a solution or even a suspension. Thus, a colloidal metal-containing liquid or fluid is considered to be a liquid or fluid as defined herein.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

In accordance with these definitions and embodiments of the present disclosure, a discussion of the various systems and methods is provided including details associated therewith. This being stated, it should be noted that various embodiments will be discussed as they relate to the systems and methods. Regardless of the context of the specific details as they are discussed for any one of these embodiments, it is understood that such discussion relates to all other embodiments as well.

The present disclosure is drawn to a multi-chamber container for storing and mixing fluids. The container can include a first chamber configured to contain a first liquid composition as well as a second chamber configured to contain a second liquid composition. A barrier can be operable to retain the first liquid composition within the first chamber. The multi-chamber container can further include a dispenser, such as a sprayer or a foam dispenser, including a nozzle and an extraction tube for extracting fluid from the second chamber as well as a guide channel associated with the first chamber. The guide channel can be configured to guide the extraction tube into the second chamber such that the dispenser comes into contact with the barrier in order to facilitate removal or reconfiguration of the barrier. The dispenser that contacts the barrier can be the extraction tube tip, a shoulder or protrusion on another portion of the dispenser, etc. Thus, this removal of the barrier from the first chamber allows the first liquid composition to contact the second liquid composition. The extraction tube or other dispenser portion can contact and, with force, remove the barrier via forced contact.

In one aspect, the disclosure provides an insert or insert module for mixing multiple fluids in a container. The insert can include a chamber configured to contain a liquid composition having an open bottom, a removable or reconfigurable barrier adapted to close the openable bottom and to retain the liquid composition within the chamber, and a guide channel associated with the chamber adapted to guide an extraction tube past the chamber. The insert can be adapted to be interface with a bottle, e.g., spray bottle or foaming bottle dispenser, and the barrier can be adapted to be removed by the dispenser, e.g., tip of extraction tube, shoulder structure, or other protrusion associated with the dispenser.

In yet another aspect, the disclosure provides a method for facilitating storing and mixing liquids. The method include obtaining a multi-chamber container including a first chamber configured to contain a first liquid composition, a second chamber configured to contain a second liquid composition, a barrier operable to retain the first liquid composition within the first chamber, and a guide channel associated with the first chamber. The method further includes facilitating removal of the barrier by passing an extraction tube through the guide channel and contacting the barrier with the dispenser so as to reconfigure or remove the barrier to cause contact of the first liquid composition and the second liquid composition.

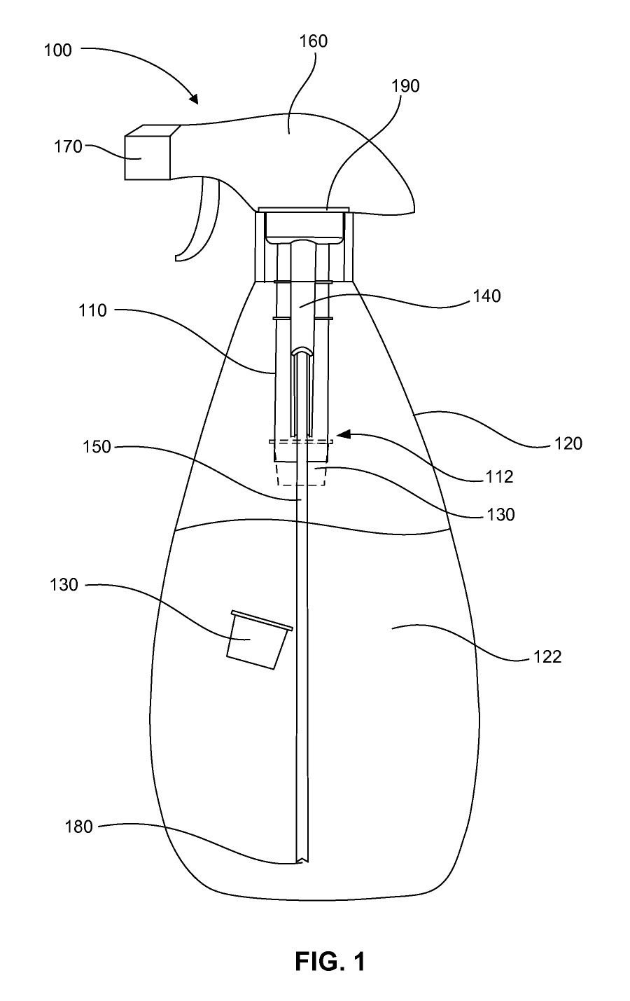

Turning now to the FIGS., FIG. 1 provides a cross-sectional schematic view of one embodiment of a multi-chamber container 100 for storing and mixing liquids, in accordance with examples of the present disclosure. The multi-chamber container can include a first chamber 110 configured to contain a first liquid composition (not shown) and a second chamber 120 configured to contain a second liquid composition 122. The multi-chamber container can further include a barrier 130 (shown prior to removal in phantom lines as well as after removal in solid lines), a guide channel 140, and a sprayer 160 including an extraction tube 150 and a spray nozzle 170. In one aspect, the first chamber can be smaller relative to the second chamber, although this need not be the case as the chambers can be of any size or configuration relative to one another. For example, the first chamber can be configured to contain a relatively small volume of a chemical concentrate, such as a peroxygen, and the second chamber can be configured to contain a relatively large volume of a diluent, such as water, alcohol, transition metal ions or colloids, etc. That being stated, it is noted that the terms “first” and “second” are merely relative terms, and thus, the first chamber can be switched with the second chamber in various embodiments described herein.

The barrier 130 can separate the first liquid composition and the second liquid composition and can cover an opening on the lower end 112 of the first chamber. In one aspect, the barrier can comprise a stopper, such as shown in FIG. 1, which is displaceable by contact with an extraction tube 150 as it is pushed down the guide channel 140. For example, the barrier (which is a stopper in this example) can be configured to interface with the first chamber 110 to cover or plug the opening and maintain the first liquid composition and the second liquid composition separate from one another. Accordingly, the stopper can be removed from an opening of the first container 110 to facilitate contact of the first liquid composition (not shown but is contained in the first container prior to removal of the stopper) as is drains into the second liquid composition 122. The first chamber and/or the second chamber 120 can be configured to facilitate mixing of the first liquid composition and the second liquid composition in one or both of the chambers. In one aspect, the first liquid composition can pour or drain from the first chamber and mix with the second liquid composition in the second chamber. Such draining from the first chamber can occur naturally under the influence of gravity alone following removal or reconfiguration of the barrier when the first chamber is disposed above the second chamber. It is noted that though this example depicts a barrier in the form of a stopper, other barriers can likewise be used, such as a puncturable membrane, a pre-perforated pop out tab or pop out trap door, etc.

In one aspect, the guide channel 140 can be associated with the first chamber 110 and can function to guide the extraction tube into contact with the barrier 130. The contact of the extraction tube 150 with the barrier can result in removal or reconfiguration of the barrier so as to allow for the first fluid and the second fluid to come into contact. In FIG. 1, the extraction tube has been inserted into the second chamber via the guide channel. In the embodiment of the FIG. 1, the barrier is a stopper which is shown in solid likes after it has been dislodged and removed from a lower end of the first chamber. In some embodiments, the barrier may contain a portion of the first fluid which portion is allowed to contact the second fluid when the barrier is dislodged from the first chamber.

The sprayer 160, including extraction tube 150 and spray nozzle 170, can be provided separately from the other components of the multi-chamber container thereby resulting in a multi-chamber container system. In such embodiments, the insert module can be disposed in the second chamber and a cap or lid can seal the opening in which the insert module is disposed. When a user is ready to remove or reconfigure the cap to allow for mixing of the first fluid and the second fluid, the cap or lid can be removed and the extraction tube can be inserted into the guide channel and the barrier removed or reconfigured, thereby allowing mixing of the two fluids. The sprayer component can be threaded or otherwise attached to the second chamber.

The multi-chamber containers, or components thereof, and associated methods of the present disclosure can be used with any multi-part liquid composition or system. The containers are particularly advantageous for multi-part compositions which have limited or shortened stabilities, shelf-lives, or functional time periods once combined. As such, in one aspect of the present disclosure, removing a barrier to facilitate contact of the first liquid composition and the second liquid composition can be performed shortly before dispensing the mixed liquids from the second chamber, such as through the sprayer 160. An example of a multi-part system which can be used herein is a multi-part disinfectant composition which, in its final form, can include a composition with an amount of a transition metal, e.g. a colloidal or ionic transition metal, and a peroxygen, e.g., peracids and/or peroxides. The composition could also include other ingredients such as alcohols or other organic co-solvents, or even dispersed particles, such as colloidal metals. Thus, the peroxygen can be separated from the transition metal until mixing, and in one embodiment, or any other two ingredients can remain separate until the mixture is formed, as would be appreciated by one skilled in the art. It is emphasized, however, that this system is not limited to this particular two part system. Any system where there are two fluids that should remain separate until activation or combination can benefit from the containers of the present disclosure. For example, a system that includes a concentrate in one of the chambers and a diluent (e.g., water, water/alcohol, etc.) in the other container would also benefit from this system. Thus, the “add water” step would occur simply by pushing the plunger. This would be useful if the concentrate was more stable than when diluted. Likewise, many other two part systems could be separated using the containers of the present disclosure.

That being stated, if the two part system is a disinfectant system, in one specific example, the above described disinfectant system can be effectively used to provide disinfection of a wide variety of surfaces. However, when a peracid is used, the peracid component of the composition can have a limited shelf-life, particularly at concentrations that are relatively low. As such, the present disclosure provides an effective means for safely packaging, handling, shipping, storing, and ultimately mixing and dispensing such a composition in a two-component format (at an initial higher concentration) until shortly before use. For example, the above described disinfectant composition could be packaged into a multi-chamber container of the present disclosure such that an aqueous vehicle, including a transition metal (ionic or colloidal) component and/or alcohol or possibly other organic components are placed in the larger second chamber of the container, while a concentrated, and thereby more stable, peracid liquid is placed in the smaller first chamber. By maintaining a somewhat elevated concentration of peracid in the liquid of the first chamber, the peracid has an enhanced stability, and therefore a longer shelf-life. Further, the present disclosure provides for a safe means for packaging such individually separated compositions. Typically, solutions having elevated peracid concentrations are viewed as being hazardous, and therefore, difficult to ship and sell to the public. The multi-chamber containers of the present disclosure would allow for the peracid liquid to be packaged within the first chamber and enclosed within the container for safety. Such a configuration makes the system more safely shipped and stored because any leak from the first chamber would be retained within the container and, if the barrier separating the chambers is removed, safely dispersed and neutralized into the second liquid present in the second chamber. Specific details of one specific type of composition which can be used in the systems of the present inventions are described in U.S. Pat. No. 7,473,675, which is incorporated herein by reference. In another aspect, compositions that can be used include a bleach concentrate with water, paint components, or any other suitable composition applicable to two part chemistries or mixtures.

The configuration of the barrier 130, and the guide channel 140, and the first chamber 110 can be particularly advantageous when the liquid present in the first chamber is a dangerous or hazardous liquid. For example, if the liquid in the first chamber is a concentrated acid, the user does not need to be exposed to the concentrated acid in order to facilitate the mixing of the acid with the liquid in the second chamber 120. The fluid within the first chamber is only exposed to an external environment when the barrier separating the first and second chambers is removed inside the multi-chamber container 100.

It should be recognized that any number of chambers and liquid compositions can be included in a multi-chamber container in accordance with the present disclosure. Moreover, it should be recognized that the channel guide and first chamber configuration can be associated in any arrangement or embodiment disclosed herein.

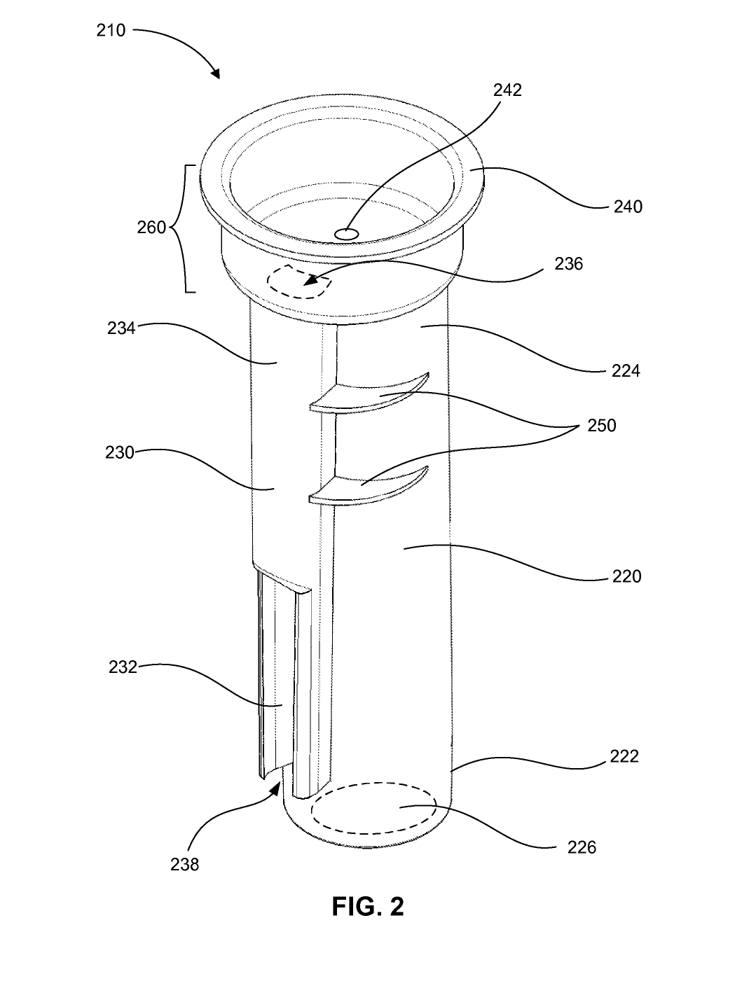

FIG. 2 shows a perspective view of an insert module 210 (shown with additional detail but similar to that shown at 110 in FIG. 1) that can be used in the multi-chamber containers of the present disclosure. The insert module can include the first chamber 220 and the guide channel 230. As shown in FIG. 2, the first chamber can be a cylinder, but can also take other shapes or configurations such as tubing that has a cross-section that is oval, square, rectangular, octagonal, hexagonal, etc. The first chamber can have a lower portion 222 and an upper portion 224. The lower portion can have an opening 226 (shown in phantom lines) which can be configured to be closed using a barrier (not shown). The barrier can be a stopper, such as that shown in FIG. 1, or a membrane, a pop-out tab, trap door, etc. The guide channel 230 can also include a lower portion 232 and an upper portion 234. The guide channel can be laterally enclosed along the entire length, along a portion of the guide channel, or can be an open channel. As shown in FIG. 2, the upper portion of the guide channel is laterally enclosed, and the lower portion of the guide channel is laterally partially enclosed (open channel). Depending on the opening in second chamber in which the insert module is inserted, in some embodiments it can be useful for the lower portion of the guide channel to be narrower than the upper portion (e.g., tapered or stepped as shown) to allow for improved insertion of the insert module into the second chamber. In one embodiment, the guide channel can have a first opening 236 proximate a top portion of the guide channel and a second opening 238 proximate the bottom portion of the guide channel.

In some embodiments, the insert module 210 can include an interface portion 260 that can form the upper portion of the insert module and can be associated with an upper region of the first chamber and an upper region of the guide channel. The interface portion can be utilized for interfacing the insert module with a body of the second chamber (not shown here, but shown at 120 of FIG. 1). The interface portion can comprise any mechanism known in the art for interfacing and/or coupling with an opening or pour spout of a container, including but not limited to threads, clamps, interference fittings, adhesives, bonding, welding, detents, etc. In one embodiment, the insert module can include a flange or flange portion 240 that is configured to engage a portion of a container or chamber into which the insert module is disposed. The insert module can therefore be screwed or threaded into/onto the container, or pushed or pressed into/onto the container. Other connection mechanisms can also be used to operably connect the insert module and the container. In one aspect, the interface portion can comprise a flange 240 configured to interface with a rim of a container or chamber about an opening. Also shown in this example are a vent 242 for venting the first chamber for fluid transfer, as well as support ribs 250, which are optional and can be used to provide structural rigidity between the guide channel 230 and a wall portion of the insert module.

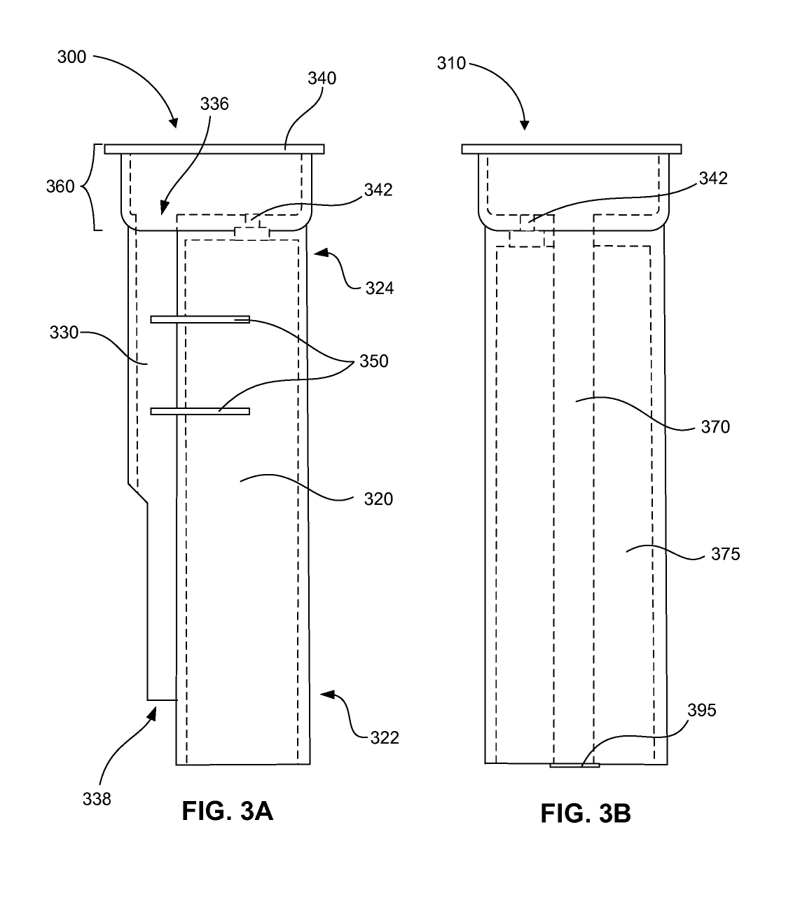

FIGS. 3A and 3B show cross-sectional schematic views of insert modules including first chambers and associated guide channels, for storing and mixing liquids. Specifically, FIG. 3A shows an embodiment of an insert module 300 similar to the embodiment shown in FIG. 2 and has a guide channel 330 that is external to the first chamber 320 offset within the interface portion 360 of the insert module. The interface portion is shown having a flange 340 to interface with a lip or rim of a second container (not shown). The first chamber includes both an upper portion 324 and a lower portion 322. The insert module of FIG. 3A includes optional ribs 350 which can be useful during the manufacturing process and can also serve to add structural integrity to the insert module. As with FIG. 2, the guide channel includes a first opening 336 for receiving an extraction tube (not shown, but shown in FIG. 1 at 150) and a second opening 338 where the extraction tube exist guide channel and enters the second chamber (not shown, but shown in FIG. 1 at 120). Also shown in these examples is a vent 342 for venting air when the first fluid composition is drained in the second fluid composition.

FIG. 3B shows a second embodiment of an insert module which is similar to that shown in FIG. 3A with a few exceptions. In this example, the first chamber 375 surrounds a generally centrally disposed guide channel 370. The embodiment shown in FIG. 3B shows a barrier layer 395 that is a puncturable membrane or foil that seals a lower portion of the guide channel. The barrier is used in this example to seal the guide channel from the first chamber so that the fluid contained there will not escape from the guide channel. The barrier could likewise be at the top of the guide channel, at the top of the interface portion, or in other configurations as would be appreciated by one skilled in the art. For example, if the barrier is a stopper as shown in FIG. 1, then the stopper can include a portion that seals the bottom of the guide channel from the interior of the first chamber. In still other examples, there may be fluids where a barrier is not included, particularly when there is not safety issue involved with leaking of the first fluid from the container. That being described, one advantage of the embodiment shown in FIG. 3A is that the guide channel does not go through the first chamber, so regardless of the fluid present in the first chamber, there is no concern about fluid leaking from the first chamber out of the top of the interface portion. The only possible exit for the first fluid in the first chamber in the FIG. 3A example is out of the bottom portion when the barrier is reconfigured or removed.

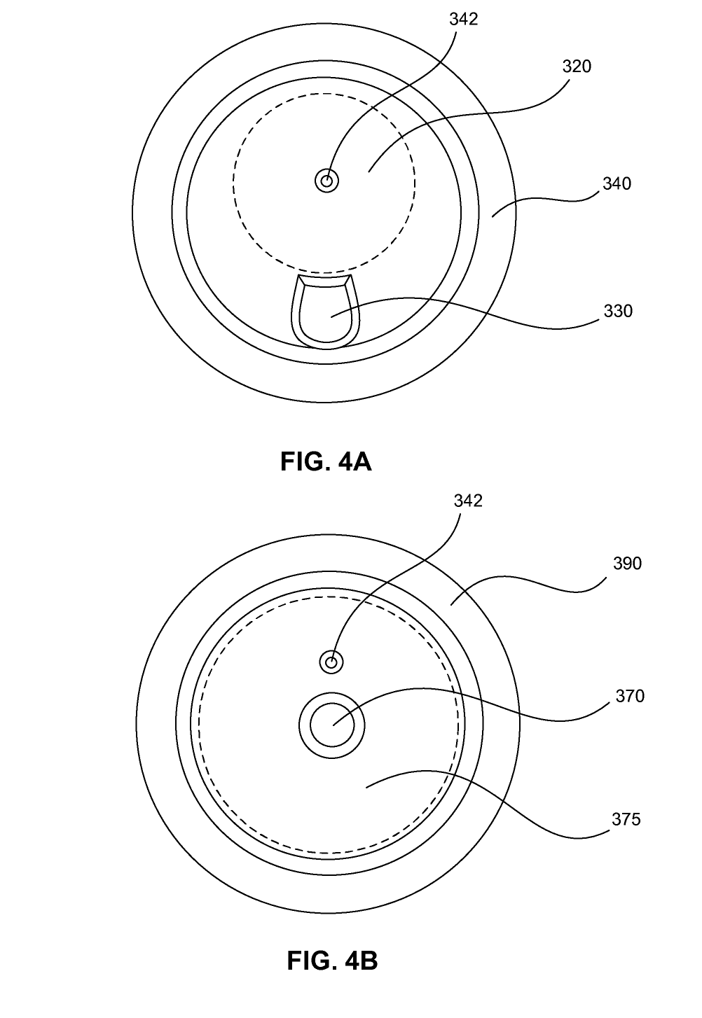

FIGS. 4A and 4B are top views of the first chamber and associated guide channel of the corresponding embodiments of FIGS. 3A and 3B, respectively, in accordance with embodiments of the present disclosure. FIG. 4A shows the location of the guide channel 330 in relationship to the first chamber 320 and the flange 340 of the interface portion. FIG. 4B shows the location of the guide channel 370, the first chamber 375, and the flange 390 of the interface portion of the embodiment in which the guide channel is centrally located within the first chamber.

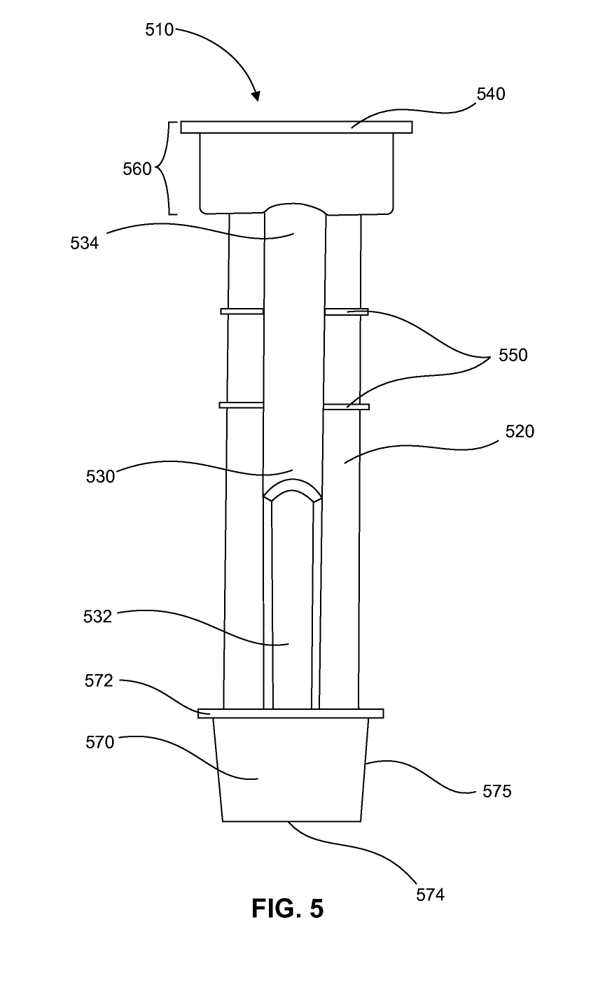

FIG. 5 is side view of an insert module 510 similar to the embodiments shown in FIGS. 2, 3A, and 4A. The insert module of FIG. 5 includes the interface portion 560 with a flange 540 configured to associate with a rim of a container (e.g., second container or chamber) into which the insert module is disposed. The insert module includes a first chamber 520 and a guide channel 530 having a substantially enclosed upper portion 534 and a partially enclosed lower portion 532. The figure further shows the relationship between the ribs 550, the first chamber, and the guide channel. The embodiment of the insert module shown in FIG. 5 also includes a barrier 570 in the form of a stopper or cap. The stopper or cap includes a flange 572 which extends outwardly in a substantially perpendicular direction from the walls of the first chamber. The flange of the stopper can function to contact the extraction tube (not shown, but shown at 150 in FIG. 1) when it is inserted into the guide channel of the insert module. Contact between the extraction tube and the flange of the stopper can cause the stopper to become dislodged from the end of lower end of the first chamber (covered by the stopper) thereby allowing the first fluid to drain into the second fluid of the second chamber (not shown, but shown at 120 in FIG. 1).

The barrier/stopper 530 can have a closed end 574, a side wall 575, and an open end (not shown). The side wall can be configured at an angle which allows the open end of the stopper to be wider than the closed end. In one aspect, the closed end of the stopper can be relatively rigid and inflexible and therefore less conducive to radial compression upon contact with the side wall of the opening upon insertion. As the side walls shown in this example are slightly tapered, a tight compression fit keeps the stopper in place until dislodged by the extraction tube.

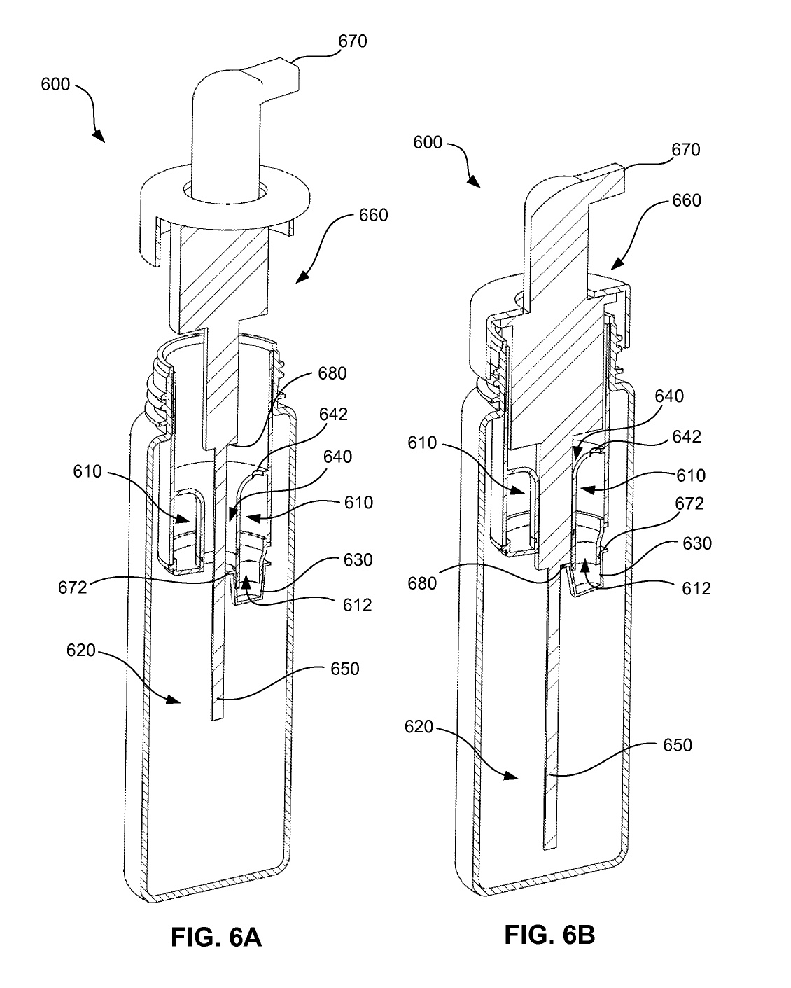

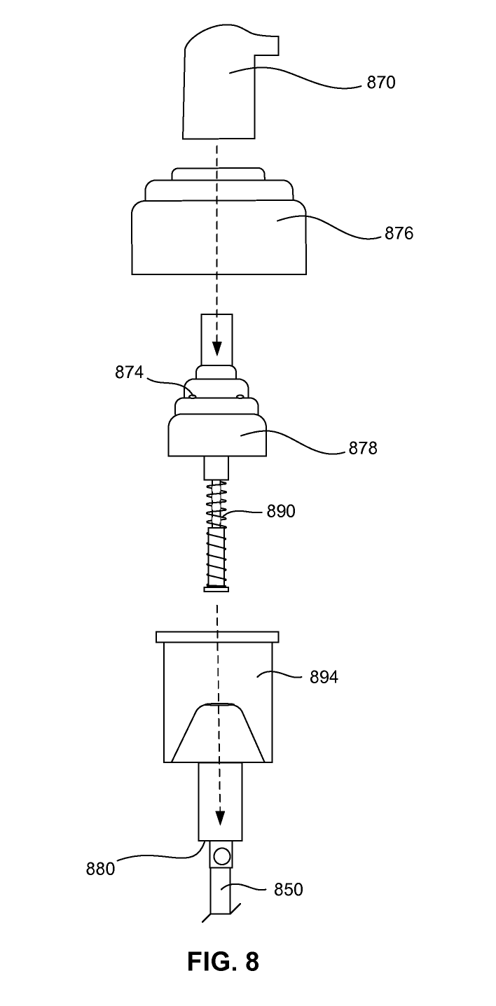

Turning now to FIGS. 6A-6C, a cross-sectional schematic view of another related embodiment of a multi-chamber container 600 for storing and mixing liquids, in accordance with examples of the present disclosure, is provided. It is noted that the discussion above as it relates to common features are also relevant to this embodiment. In this example, the multi-chamber container can include a first chamber 610 configured to contain a first liquid composition (not shown) and a second chamber 620 configured to contain a second liquid composition. The multi-chamber container can further include a barrier 630 (shown prior to removal in FIG. 6A, shown just as it is being pried open in FIG. 6B, and shown after the barrier has been completely removed in FIG. 6C at a slightly different perspective), a guide channel 640, and a foam dispenser 660 (including a mixing chamber for mixing fluid and air to generate a foam, not shown in these FIGS. but shown in some detail in FIG. 8 hereinafter), an extraction tube 650, and a foam nozzle 670. Again, the first chamber also includes a vent 642. In one aspect, the first chamber can be smaller relative to the second chamber, although this need not be the case as the chambers can be of any size or configuration relative to one another. For example, the first chamber can be configured to contain a relatively small volume of a chemical concentrate, such as a peroxygen, and the second chamber can be configured to contain a relatively large volume of a diluent, such as water, alcohol, transition metal ions or colloids, etc. That being stated, it is noted that the terms “first” and “second” are merely relative terms, and thus, the first chamber can be switched with the second chamber in various embodiments described herein.

In foaming dispenser examples, in addition to the disinfectants or other ingredients included in the first or second liquid compositions, additives can be included in the first and/or second chamber that are suitable for facilitating the formation of a foam. Thus, when the foam dispenser is pumped, the (mixed) liquid compositions are pumped up through the extraction tube 650 and mixed with air within the foam dispenser 660 to form and deliver the foam from the foam nozzle 670.

As previously mentioned, the barrier 630 can separate the first liquid composition and the second liquid composition and can cover an opening 612 on the lower end of the first chamber. In one aspect, the barrier can comprise a stopper, such as shown in FIGS. 6A and 6B, which is displaceable by contact with an extraction tube 650 as it is pushed down the guide channel 640. However, in the example shown, the stopper is not displaced by the extraction tube tip, but rather, is displaced by a shoulder 680 of the dispenser that is distal to the tip, i.e. further up along the extraction tube. The shoulder can be said to be part of the extraction tube, or alternatively, part of the foam dispenser. In either case, the shoulder is immediately adjacent to the extraction tube and is used to displace the barrier or stopper, and thus, is described herein to be part of the extraction tube (whether integrated or assembled therewith). The extraction tube could likewise include other protrusions or assemblies with other structures to provide the same or similar function, and can be adapted to move coincident with the extraction tube, and such protrusions or assembly can be said to be integrated and/or part of the extraction tube for purposes of removal of the barrier described herein. Thus, when the shoulder comes into contact with a flanged or rim portion 672 of the stopper, as the force of the shoulder is moved downward (such as by screwing or otherwise forcing the foam dispenser down on the bottle), the stopper will be removed and the first liquid composition can be drained into the second liquid composition. Furthermore, the first chamber 610 and/or the second chamber 620 can be configured to facilitate mixing of the first liquid composition and the second liquid composition in one or both of the chambers. In one aspect, the first liquid composition can pour or drain from the first chamber and mix with the second liquid composition in the second chamber. Such draining from the first chamber can occur naturally under the influence of gravity alone following removal or reconfiguration of the barrier when the first chamber is disposed above the second chamber. It is noted that though this example depicts a barrier in the form of a stopper, other barriers can likewise be used, such as a puncturable membrane, a pre-perforated pop out tab or pop out trap door, etc.

In one aspect, the guide channel 640 can be associated with the first chamber 610 and can function to guide the extraction tube into contact with the barrier 630. The contact of the shoulder 680 with the barrier can result in removal or reconfiguration of the barrier so as to allow for the first fluid and the second fluid to come into contact. In FIG. 6A, the extraction tube is shown to be inserted into the second chamber via the guide channel, but in this example, the guide channel is wider than needed by the thinner portion of the extraction tube. However, in this example, the extraction tube/foam dispenser has a wider portion that ultimately passes through the guide channel to remove the stopper as previously described.

The foam dispenser 660, including an air mixing region (not shown), extraction tube 650, and foam nozzle 670, can be provided separately from the other components of the multi-chamber container, thereby resulting in a multi-chamber container system. In such embodiments, the insert module can be disposed in the second chamber and a cap or lid can seal the opening in which the insert module is disposed. When a user is ready to remove or reconfigure the cap to allow for mixing of the first fluid and the second fluid, the cap or lid can be removed and the extraction tube can be inserted into the guide channel and the barrier removed or reconfigured when contacted with the shoulder, thereby allowing mixing of the two fluids. The foam dispenser can be threaded or otherwise attached to the second chamber for this purpose.

The configuration of the barrier 630, and the guide channel 640, and the first chamber 610 can be particularly advantageous when the liquid present in the first chamber is a dangerous or hazardous liquid. For example, if the liquid in the first chamber is a concentrated acid, the user does not need to be exposed to the concentrated acid in order to facilitate the mixing of the acid with the liquid in the second chamber 620. The fluid within the first chamber is only exposed to an external environment when the barrier separating the first and second chambers is removed inside the multi-chamber container 600. Then, once mixed, the extraction tube 650 can be used to pump the mixed liquid up into the foam dispenser where it is mixed with air to form a foam, and dispensed.

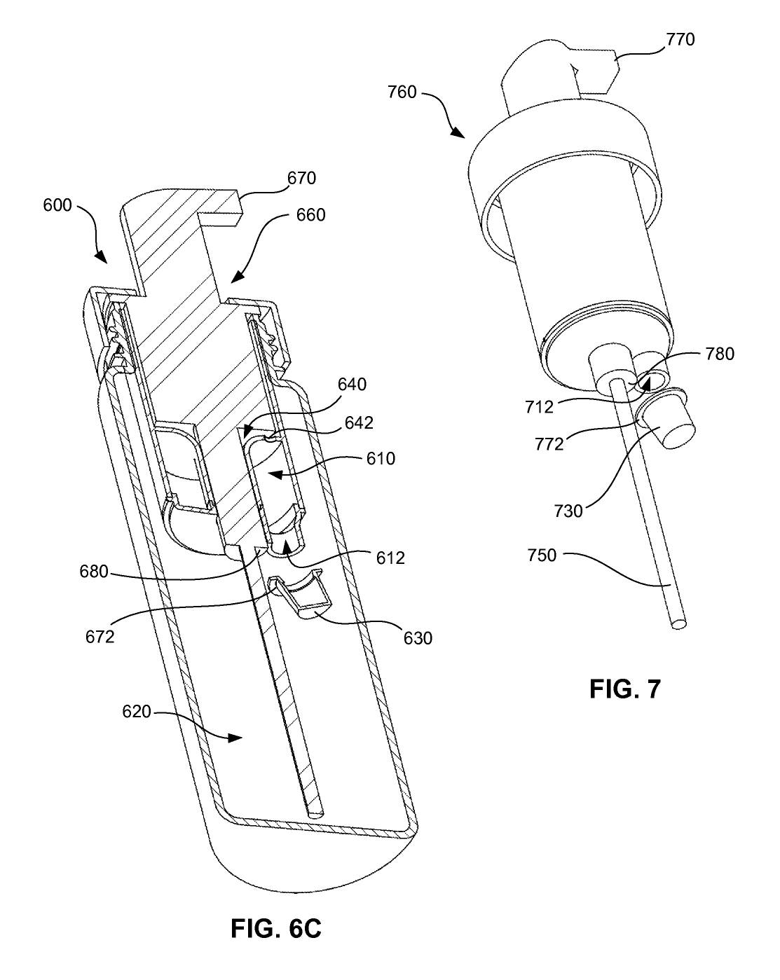

Turning now to FIG. 7, a lower perspective view of a foam dispenser 760 similar to that shown in FIGS. 6A-6C is provided. The foam dispenser includes an extraction tube 750 for withdrawing fluid from a second liquid composition chamber (not shown) and into an air mixture region (not shown, but shown in FIG. 8) within the foam dispenser. Essentially, air is pumped from an air reservoir through one or more air aperture as the liquid is simultaneously pumped from the second chamber, thereby generating foam. When the air is mixed quickly with the fluid that is extracted from the second chamber into the air mixture region, and if the formulation has suitable surfactants or other additives known in the art for generating foams, a foam is generated for dispensing from the foam nozzle 770. The first liquid composition chamber (also not shown, but shown in FIGS. 6A-6C) in this example is housed adjacent to a body of the foam dispenser. Thus, when the shoulder 780 adjacent the extraction tube is pushed through a guide channel (not shown) and into contact with the rim portion or flange 772 of the barrier 730, the barrier is removed and an opening 712 is exposed, allowing fluid mixing from the first chamber into the second chamber.

FIG. 8 depicts a single example of a foam generating apparatus that can be used in accordance with examples of the present disclosure. The exploded view shows how the various parts are assembled. With specific reference to the mechanism that generates foam, the (mixed) liquid composition is extracted from the second chamber via the extraction tube 850 into an air mixing region within the foam dispenser. In the example shown, a spring 890 is used for providing a rebounding action for the pump. An air chamber 894 is also present for use as an air reservoir to facilitate fluid flow into the air mixing region. A plunger portion 878 with vents 874 is used to provide air flow and create the air pressure and ultimately, provide air flow into the mixing region, followed by rebounding via the spring. Thus, the rapid mixing of the air and the liquid composition in a mixing region causes the fluid to form the foam for dispensing. Typically, foam nozzle 870 includes an internal screen (not shown), and is coupled to a bottle (not shown) by collar 876. Also, as previously described, a shoulder 880 on or associated with the extraction tube or elsewhere on the dispenser is present for removing the barrier (not shown) of the first chamber (also not shown, but shown in detail in FIGS. 6A-6C).

It is noted that the various components and elements of the insert modules set forth in the various embodiments disclosed herein can be formed of a single unitary structure or as one or more individual components assembled and coupled together. For example, a first chamber, the guide channel, and/or the interface portion can be formed separately and can be welded, glued, heat sealed, bonded, adhered, or otherwise coupled together to form the chamber.

In some embodiments of the present disclosure, the first and or second chamber can include a vent operable to facilitate venting of the chamber. In one embodiment, the first chamber can include a vent to facilitate venting of the chamber. In one aspect, the vent can comprise a one-way valve to facilitate the escape of gas from the first chamber without allowing for the escape of liquid from the first chamber. In another aspect, the vent can be configured to facilitate draining of the first chamber when the barrier is displaced, reconfigured, or removed. The vent can be of any suitable type or configuration, such as comprising a gas permeable barrier and/or a valve.

In accordance with one embodiment of the present disclosure, a method for facilitating storing and mixing liquids is also disclosed. The method includes obtaining a multi-chamber container including a first chamber configured to contain a first liquid composition, a second chamber configured to contain a second liquid composition, a barrier operable to retain the first liquid composition within the first chamber and a guide channel associated with the first chamber. The method further includes facilitating removal of the barrier by passing an extraction tube through the guide channel and contacting the barrier so as to reconfigure or remove the barrier to cause contact of the first liquid composition and the second liquid composition.

It is to be understood that the embodiments of the disclosure are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment,” “an embodiment,” “an example,” etc. means that a particular feature, structure, or characteristic described in connection with the embodiment is included in at least one embodiment of the present disclosure. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A multi-chamber container for storing and mixing liquids, comprising:
a first chamber configured to contain a first liquid composition;
a second chamber configured to contain a second liquid composition;
a barrier operable to retain the first liquid composition within the first chamber;
a dispenser including a nozzle and an extraction tube for extracting fluid from the second chamber; and
a guide channel associated with the first chamber, the guide channel configured to guide the extraction tube of the dispenser into the second chamber such that the dispenser comes into contact with the barrier in order to facilitate removal or reconfiguration of the barrier, thereby allowing the first liquid composition to contact and become admixed with the second liquid composition.

2. The multi-chamber container of claim 1, wherein the barrier comprises a stopper that covers an open end of the first chamber and which is displaceable by contact of the dispenser with the barrier.

3. The multi-chamber container of claim 2, wherein the stopper includes a flange which extends outwardly with respect to a wall of the first chamber and which is configured to be contacted by the dispenser for removal of the stopper from the first chamber.

4. The multi-chamber container of claim 2, wherein the stopper is configured to interface with the first chamber to plug an opening of the first chamber and maintain the first liquid composition and the second liquid composition separate from one another.

5. The multi-chamber container of claim 4, wherein the stopper comprises a angled side wall configured to expand upon compression over the opening.

6. The multi-chamber container of claim 1, wherein the barrier comprises a membrane or pop out tab puncturable or removable by the dispenser.

7. The multi-chamber container of claim 6, wherein the membrane covers an opening configured to drain the first liquid composition from the first chamber.

8. The multi-chamber container of claim 1, further comprising an interface portion which is associated with an upper region of the first chamber and an upper region of the guide channel.

9. The multi-chamber container of claim 8, wherein the interface portion includes a rim configured to associate with a portion of the second chamber.

10. The multi-chamber container of claim 1, wherein the guide channel has a first opening proximate a top portion of the guide channel and a second opening proximate the bottom portion of the guide channel.

11. The multi-chamber container of claim 10, wherein the guide channel is external to the first chamber.

12. The multi-chamber container of claim 10, wherein at least a portion of the guide channel is disposed within the first chamber.

13. The multi-chamber container of claim 1, wherein the first chamber and the second chamber are configured to facilitate mixing of the first liquid composition and the second liquid composition in at least one of the first chamber or the second chamber.

14. The multi-chamber container of claim 13, wherein the first chamber is disposed above the second chamber.

15. The multi-chamber container of claim 13, wherein the first chamber is substantially encapsulated within the second chamber.

16. The multi-chamber container of claim 1, further comprising a vent operable with the first chamber to facilitate venting of the first chamber.

17. The multi-chamber container of claim 16, wherein the vent comprises a one-way vent to facilitate venting of a gas from the first chamber.

18. The multi-chamber container of claim 1, wherein the dispenser is a sprayer and the nozzle is a spray nozzle.

19. The multi-chamber container of claim 1, wherein the dispenser is a foam dispenser pump.

20. The multi-chamber container of claim 19, wherein the foam dispenser pump includes both the extraction tube for dispensing liquid composition, as well as an air pump for admixing air with the liquid composition to generate a foam.

21. The multi-chamber container of claim 1, wherein the dispenser comes into contact with the barrier at an extraction tube tip in order to facilitate removal or reconfiguration of the barrier.

22. The multi-chamber container of claim 1, wherein the dispenser comes into contact with the barrier at protrusion or assembly that is adjacent to the extraction tube in order to facilitate removal or reconfiguration of the barrier.

23. The multi-chamber container of claim 1, wherein the first chamber contains the first liquid composition.

24. The multi-chamber container of claim 23, wherein the second chamber contains the second liquid composition.

25. The multi-chamber container of claim 24, wherein the first liquid composition includes a peroxygen and the second liquid composition includes a transition metal.

26. The multi-chamber container of claim 25, wherein the transition metal includes colloidal silver.

27. The multi-chamber container of claim 25, wherein the peroxygen includes a peroxide.

28. The multi-chamber container of claim 25, wherein the peroxygen includes a peracid.

29. The multi-chamber container of claim 24, wherein the first liquid composition includes a concentrate and the second liquid composition is at least predominantly water.

30. The multi-chamber container of claim 24, wherein one or both of the first liquid composition or the second liquid composition contains a foaming agent suitable to generate a foam when rapidly admixed with air.

31. An insert for mixing multiple fluids in a dispenser container, comprising:
a chamber configured to contain a liquid composition, said chamber having an open bottom;
a removable or reconfigurable barrier adapted to close the openable bottom and to retain the liquid composition within the chamber; and
a guide channel associated with the chamber adapted to guide an extraction tube along or through the chamber without contacting the liquid composition prior to reconfiguration or removal of the barrier,
wherein the insert is adapted to interface with a dispenser bottle, and the barrier is adapted for removal upon insertion of the extraction tube.

32. The insert of claim 31, wherein the barrier comprises a stopper that covers the openable bottom of the chamber and which is displaceable by contact with the dispenser as the extraction tube is passed through the guide channel.

33. The insert of claim 32, wherein the stopper includes a flange which extends outwardly from a wall of the stopper such that as the extraction tube passes through the guide channel, the stopper is displaced by contact between the flange and the dispenser.

34. The insert of claim 32, wherein the stopper comprises an angled side wall configured be pressure fit over the opening.

35. The insert of claim 31, wherein the barrier comprises a membrane puncturable by the dispenser as the extraction tube it is passed through the guide channel.

36. The insert of claim 35, wherein the membrane covers an opening configured to drain the first liquid composition from the chamber.

37. The insert of claim 31, further comprising an interface portion which is associated with an upper region of the chamber and an upper region of the guide channel.

38. The insert of claim 31, wherein the guide channel has a first opening proximate a top portion of the guide channel and a second opening proximate the bottom portion of the guide channel.

39. The insert of claim 38, wherein the guide channel is external to the chamber.

40. The insert of claim 38, wherein at least a portion of the guide channel is disposed within the chamber.

41. The insert of claim 31, further comprising a vent operable with the chamber to facilitate venting of the chamber.

42. The insert of claim 41, wherein the vent comprises a one-way vent to facilitate venting of a gas from the first chamber.

43. The insert of claim 31, wherein the barrier is adapted for removal or reconfiguration when a tip of the extraction tube is pressed with force against the barrier.

44. The insert of claim 31, wherein the barrier is adapted for removal or reconfiguration when a protrusion or shoulder of the dispenser is pressed with force against the barrier.

45. A method for facilitating storing and mixing liquids, comprising:
obtaining a multi-chamber container including a first chamber configured to contain a first liquid composition, a second chamber configured to contain a second liquid composition, a barrier operable to retain the first liquid composition within the first chamber, a guide channel associated with the first chamber, and a dispenser including a nozzle and an extraction tube for extracting fluid from the second chamber and out of the nozzle; and
facilitating removal of the barrier by passing an extraction tube through the guide channel and contacting the barrier with the dispenser so as to reconfigure or remove the barrier to cause contact and mixing of the first liquid composition and the second liquid composition.

46. The method of claim 45, wherein the dispenser is a spray dispenser adapted to dispense the fluid from the second chamber in the form of a spray.

47. The method of claim 45, wherein the dispenser is a foam dispenser adapted to mix air with the fluid upon extraction from the second chamber to form a foam.

48. The method of claim 45, wherein the barrier comprises a stopper displaceable by the dispenser.

49. The method of claim 48, wherein the extraction tube displaces the stopper via a tip of the extraction tube.

50. The method of claim 48, wherein the dispenser displaces the stopper via a protrusion or shoulder positioned on the dispenser.

51. The method of claim 45, wherein the barrier comprises a membrane puncturable by the extraction tube.

52. The method of claim 45, wherein the first liquid composition includes a peracid.

53. The method of claim 45, wherein the second liquid composition includes an alcohol.

54. The method of claim 45, wherein the second liquid composition includes a transition metal.

55. The method of claim 54, wherein the transition metal is colloidal silver.

56. The method of claim 45, wherein the first liquid composition includes a concentrate and the second liquid composition is at least predominantly water.
